(19) United States
(12) Patent Application Publication
(10) Pub. No.: US 2026/0009269 A1
(43) Pub. Date: Jan. 8, 2026

(54) WINDOW REGULATOR ASSEMBLY WITH RAIL SLIDER FOR A WINDOW PANE

(71) Applicant: Brose Fahrzeugteile SE & Co. Kommanditgesellschaft, Bamberg, Bamberg (DE)

(72) Inventors: Bert ALMES, Leuna (DE); Hans HERZOG, Strullendorf (DE); Norman HUEMMER, Ebensfeld (DE); Michael JAHN, Bad Staffelstein (DE); Joerg MUELLER, Ahorn (DE); Udo TAUBMANN, Bad Rodach - Suelzfeld (DE); André BERNHARD, Rattelsdorf (DE)

(73) Assignee: Brose Fahrzeugteile SE & Co. Kommanditgesellschaft, Bamberg, Bamberg (DE)

(21) Appl. No.: 19/231,414

(22) Filed: Jun. 6, 2025

(30) Foreign Application Priority Data
Jul. 7, 2024 (DE) 10 2024 205 298.1
Sep. 17, 2024 (DE) 10 2024 208 873.0

(51) Int. Cl. E05D 15/16

(52) U.S. Cl. CPC E05D 15/165

(57) ABSTRACT

A window regulator assembly for an adjustable window pane of a motor vehicle, comprising a rail slider movably guided on a guide rail with two clamping legs, between which a receiving gap for the window pane is formed. Mutually spaced support contours for the window pane are molded to one of the clamping legs on both sides of the receiving gap, in particular to form a two-point support.

This nonprovisional application claims priority under 35 U.S.C. § 119(a) to German Patent Application No. 10 2024 205 298.1, which was filed in Germany on Jun. 7, 2024 and to German Patent Application No. 10 2024 208 873.0, which was filed in Germany on Sep. 17, 2024 and which are both herein incorporated by reference.

### BACKGROUND OF THE INVENTION

### Field of the Invention

The invention relates to a window regulator assembly for an adjustable window pane of a motor vehicle, with a rail slider that can be moved on a guide rail with two clamping legs connected by at least one connecting leg, between which a receiving gap for the window pane is formed. The invention also relates to a rail slider for such a window regulator assembly of a motor vehicle.

### Description of the Background Art

Movable vehicle window panes are usually moved between a closed position and an open position by electrically or electromotively operated actuators as motor vehicle window regulators. Such a window regulator usually includes an electromotive (adjusting) actuator as well as an adjustment mechanism of a window regulator assembly that connects the actuator to the window pane or couples it by power transmission technology, which assembly is assigned to a vehicle door or a body of a motor vehicle.

To guide the window pane, it is equipped with at least one rail slider with a driving function for the vehicle window on a vehicle door, for example on a lower edge of the window (window lower edge). The rail slider is typically guided in at least one guide rail of the window regulator assembly, which acts as an adjustment or guide track, along an adjustment path oriented in the direction of the vehicle height (Z direction).

The rail slider, which is typically made of an injection-molded plastic, has a base body with a guide area, which surrounds the guide rail as a rail wrap when assembled. In other words, the guide rail sits in the guide area of the rail slider and is enclosed in areas or sections. The rail slider and the guide rail are thus engaged with each other. The rail slider is mounted along the guide rail so that the window pane is guided linearly between the closed position and the open position. For example, the rail slider is coupled with a pane holder as a (pane) driver for mechanical connection to the window pane.

To connect the rail slider to the window pane, for example, it has two driver or clamping legs, which are designed and intended to hold the window pane to be adjusted, for example by clamping it between them. For this purpose, the clamping legs are movable relative to each other. The window pane is held with its lower edge between the clamping legs of the rail slider and then clamped or jammed between them by bringing the two clamping legs closer together.

The rail slider can be designed for screw-free snapping (clip-in) of the window pane. From DE 10 2012 223 825 A1, which is incorporated herein by reference, for example, it is known to connect a driver with rail slider function to the window pane without tools via an elastically displaceable locking section with a locking lug. In this case, the locking section for the connection of the window pane with the driver can be elastically relocated against a restoring force, so that the locking lug of the locking section is brought into engagement with a locking opening on the side of the pane as a result of the restoring force, thus establishing the connection of the window pane with the driver.

In particular, in the case of a conventional window regulator assembly with only a single guide rail, a so-called single-strand window regulator, there is a risk of the window pane tilting in relation to the rail slider, which can lead to undesirable noise, especially in an upper and/or lower end position of the rail slider sliding along the guide rail.

### SUMMARY OF THE INVENTION

It is therefore an object of the invention to specify a window regulator assembly with a particularly suitable rail slider for a window pane of a motor vehicle. Furthermore, a suitable rail slider for such a window regulator assembly (window regulator) is provided. In particular, the rail slider should be manufactured cost-effectively or material-saving.

In the following, information is specified regarding the spatial directions in a coordinate system of the motor vehicle (vehicle coordinate system) with regard to the exemplary installation situation in a side door of the motor vehicle. The abscissa axis (X-axis) is oriented along the longitudinal direction of the vehicle, the ordinate axis (Y-axis) along the transverse direction of the vehicle, and the applicate axis (Z-axis) along the height of the vehicle.

The window regulator assembly for an adjustable window pane of a motor vehicle, hereinafter can also be referred to as a window regulator or cable window regulator, has a rail slider that is guided on a guide rail in a sliding manner. The rail slider can have two clamping legs connected by at least one connecting leg, preferably by two mutually spaced connecting legs between which a receiving gap for the window pane is formed.

The at least one connecting leg can be roughly U-shaped and can be preferably molded to the two clamping legs. The clamping legs of the rail slider can be connected via two mutually spaced connecting legs and projected outwards in the longitudinal direction of the gap. In other words, the connecting legs protrude outwards in a U-shape or V-shape in the longitudinal direction of the gap on the side of the slider opposite a gap opening leading into the receiving gap.

Via the gap opening, which is opposite the connecting leg or each connecting leg, the window pane can be inserted into the receiving gap between the clamping legs. The window pane can be inserted in the longitudinal gap direction between the gap opening and the connecting leg of the receiving gap along the clamping legs. In the typical vehicle coordinate system, the longitudinal gap direction is oriented in the Z-direction.

One of the two clamping legs of the rail slider can be designed to hold and guide the rail slider on the guide rail. This (first) clamping leg has a rail wrap for the guide rail. The rail wrap is molded to the leg side of the first clamping leg facing away from the receiving gap and has an approximately L-shaped guide contour, which corresponds to a respective profile section of the Z-shaped or DIN rail-like guide rail, for example.

The other (second) clamping leg of the rail slider can be relocated elastically (elastically bendable) in relation to the first clamping leg, in particular by means of the at least one connecting leg. Appropriately, the second clamping leg of the rail slider has a locking element protruding into the receiving gap, which engages in a locking opening on the pane side when the window pane is inserted into the receiving gap of the rail slider. Appropriately, the locking element has an inlet slope inclined to the connecting leg or each connecting leg. The locking element can have a locking edge that does not slope to the gap opening of the receiving gap, with which the locking element engages the locking opening of the window pane.

Support contours spaced from each other on both sides of the receiving gap, in particular to form a two-point support for the window pane, are molded to the first clamping leg of the rail slider. Advantageously, the outer distance of the support contours may be less than or equal to the length of the rail slider in the gap longitudinal direction. In other words, the distance (in the Y direction) of the outer edges or outer surfaces of the support contours is preferably less than or equal to the length of the rail slider in the gap longitudinal direction (Z direction).

Appropriately, one of the two support contours can be molded directly opposite the rail wrap on the first clamping leg of the rail slider. Advantageously, the support contours to the side of the receiving gap are directly or immediately adjacent to it.

The support contours are provided outside the receiving gap of the rail slider and are preferably designed as a U-shaped support groove. Suitably, the respective support contour is U-shaped with a first U-leg and a second U-leg, the first U-leg being formed by the first clamping leg of the rail slider, and the second U-leg being molded to the first clamping leg of the rail slider via a connecting leg. The connecting leg is molded perpendicular to the clamping leg or to the first U-leg running to the clamping leg of the rail slider. In other words, one of the U-legs (first U-leg) of the respective support contour is formed by the first clamping leg of the rail slider or by a corresponding leg section of the first clamping leg in the gap longitudinal direction, while the other U-leg (second U-leg) of the respective support contour, hereinafter also referred to as the free U-leg, extends beyond the receiving gap, in particular parallel to the clamping leg of the rail slider, towards the other clamping leg.

The U-shaped support groove formed between the U-legs of the respective support contour aligns with the receiving gap. In particular, the groove base practically forms a flat support of the support contour for the lower edge of the window pane. Conveniently, the respective support contour supports the window pane inwards in the Y-direction and outwards in the Y-direction. Advantageously, the respective support contour supports the window pane in both Y-directions and in the Z-direction (downwards).

Appropriately, the contour sides of the support contours or the U-legs or groove legs of the support contours facing away from the receiving gap align with the lateral outer edge or outer surface of the first clamping leg of the rail slider. Ideally, the support contours provided outside the receiving gap overlap the second clamping leg at least partially or with the free U-leg, preferably with as little slit or gap formation as possible.

Advantageously, the leg edges oriented in the gap longitudinal direction or leg surfaces of the two clamping legs of the rail slider run parallel to each other or to the other clamping leg. This enables a particularly material-saving production of the rail slider with the support contours provided outside and on both sides of the receiving gap. In addition, there is a high, or at least sufficient, stability of the rail slider with a small size, in particular a small slider width (in relation to the vehicle coordinate system in the X direction).

According to the invention, the rail slider can have clamping legs that can be elastically moved against each other, between which a receiving or clamping gap is formed. Support contours are provided on one of the clamping legs outside or on both sides of the receiving gap, spaced apart from each other, the distance between which on the outer edge or outer edge side or outer surface side is less than or equal to the length of the receiving gap in the gap longitudinal direction. As a particular advantage, the rail slider is designed or manufactured as a two-component plastic part with a soft component provided in the support contours.

The advantages achieved by the invention include, in particular, in the fact that with the support contours for the window pane, formed on both sides or outside the receiving gap on one of the clamping legs of the rail slider of the window regulator assembly, improved stability is achieved during the pane stroke of the window pane moved along with the rail slider, in particular in the case of a single-strand window regulator with only a single guide rail, due to the resulting two-point support on the one hand as compared to only a single support or contact point between the clamping legs. This avoids turning or swivelling movements or tilting of the window pane in relation to the rail slider and thus undesirable noise development when adjusting the window pane between its open and closed positions. On the other hand, due to the small size of the rail slider, due to the small width of the rail slider (slider width) in the transverse direction of the receiving gap (gap transverse direction), a particularly material-saving production of the rail slider is achieved.

In addition, during the production of the rail slider, demolding in the pane or glass removal direction is possible, thus enabling a high level of functional integration with low tool investments and machine-optimized tool size due to the comparatively small projected area. In particular, in the case of a rail slider with the window pane locked between the clamping legs or by means of a clamping leg, the locking element and/or the at least one connecting leg or bar, in particular instead of lateral sliders, can be demolded in the longitudinal direction of the receiving gap via the gap opening.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows in a schematic representation, a window regulator assembly with an actuator (actuator motor) and with a rail slider coupled to a guide rail with a driving function for a window pane of a motor vehicle,

FIGS. 2 and 3 show in perspective representations, the rail slider with a receiving gap (pane gap) for the window pane formed between clamping legs, with a view to a first clamping leg designed to support and guide the rail slider on the guide rail with a support contour for the window pane molded to the side of the receiving gap,

FIG. 4 shows the rail slider in a front side view with a view over a gap opening into the receiving gap and into support contours molded to the clamping leg on both sides of the receiving gap, and

FIG. 5 shows the rail slider in a plan view of the second clamping leg with support contours immediately adjacent to it laterally.

### DETAILED DESCRIPTION

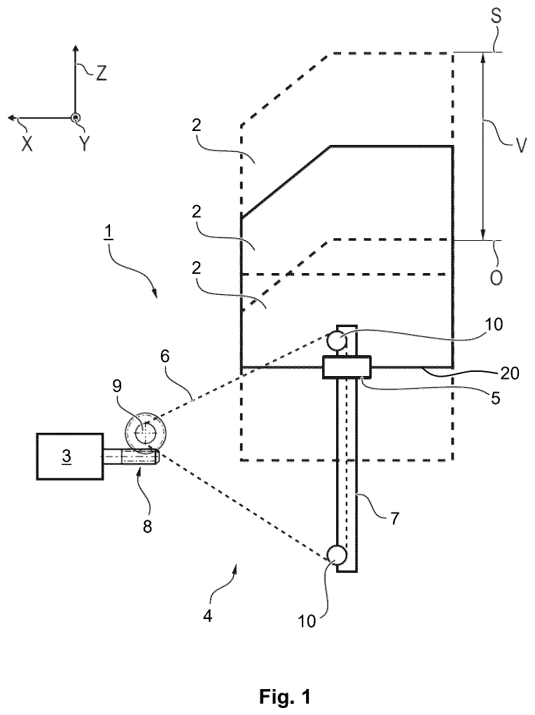

FIG. 1 shows in a schematic representation an electric or electromotive window regulator assembly (window regulator) 1 as an adjusting device for a window pane 2 of a motor vehicle, in particular a vehicle door. The window regulator assembly 1 is assigned an actuator or adjustable actuator 3, in particular an electromotive one, which acts on the window pane 2 by means of an adjustment mechanism 4 with a rail slider 5 of the window regulator assembly 1. In the example, the adjustment mechanism 4 of the window regulator assembly 1 has a traction cable 6 and a guide rail 7, on which the rail slider 5 is guided along an adjustment range V in a sliding motion. Several, for example two, traction cables 6 and two rail sliders 5 and guide rails 7 guiding these may also be provided to form a two-strand window regulator.

The servo drive 3 of the window regulator assembly 1 drives a cable drum 9 of the adjustment mechanism 4 via a worm or spur gear 8. The traction cable 6 is coupled to the cable drum 9 in such a way that when the cable drum 9 is rotated by the gearbox 8, the traction cable 6 is wound up and unwound. The traction cable 6 of a cable pull designed as a Bowden cable, for example, is guided via deflection elements or deflection pulleys 10 and coupled with the rail slider 5 with a driving function for the window pane 2. The rail slider 5 is guided along the guide rail 7, wherein the window pane 2 is also moved.

When the servo drive 3 is activated, the window pane 2 is moved along the adjustment range V into its set or desired (pane) position. The window pane 2 can be moved reversibly between a closed position S, which represents the highest possible position, and an open position O, which represents the lowest possible position. In these positions S and O, the window pane 2 is indicated in FIG. 1 with dashed lines, while the window pane 2 is shown in a half-open intermediate position by solid lines.

The following is information regarding the spatial directions in a coordinate system of the motor vehicle (vehicle coordinate system) with regard to the exemplary installation situation in a side door of the motor vehicle. The abscissa axis (X-axis) is oriented along the longitudinal direction of the vehicle, the ordinate axis (Y-axis) along the transverse direction of the vehicle, and the applicate axis (Z-axis) along the height of the vehicle.

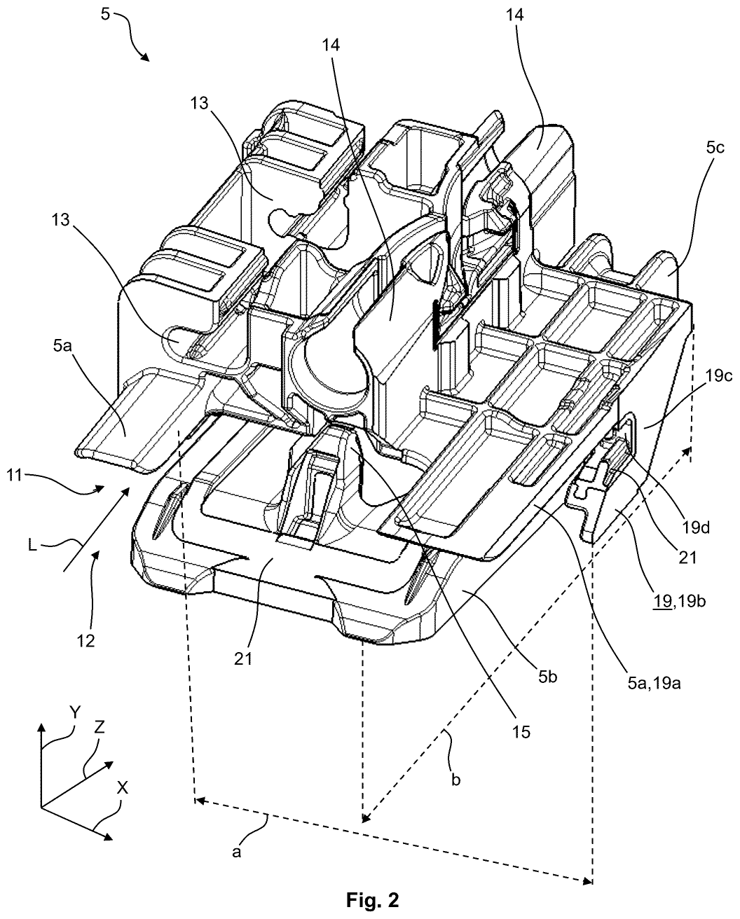

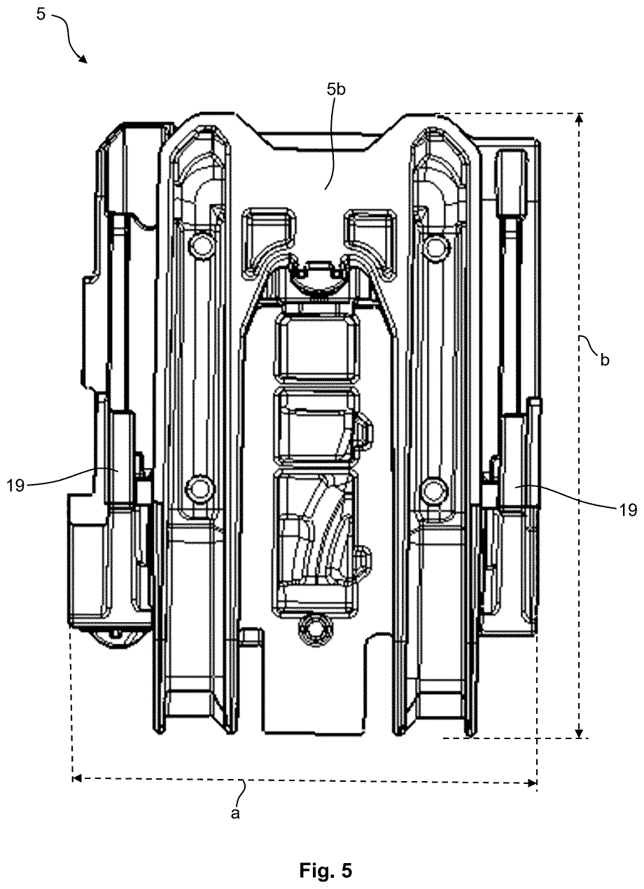

FIGS. 2 to 5 show the rail slider 5 in different views. The orientation of the rail slider 5 shown corresponds to the directions X, Y, Z of the vehicle coordinate system shown. The rail slider 5 is roughly U-or V-shaped and has a first clamping leg 5a and a second clamping leg 5b. Between the clamping legs 5a and 5b, a receiving or pane gap 11 with a gap opening 12 is formed. The clamping legs 5a and 5b are preferably connected to each other by means of two connecting legs 5c spaced from each other in the X direction, which are molded to the clamping legs 5a, 5b on the (lower) narrow side of the leg, opposite the gap opening 12. The respective connecting leg 5c is approximately U-shaped and curved or flared outwards in the Z direction.

The window pane 2 can be inserted into the receiving gap 11 between the clamping legs 5a, 5b via the gap opening 12. The window pane 2 is inserted in the gap longitudinal direction L of the receiving gap 11 running between the gap opening 12 and the respective connecting leg 5c along the clamping legs 5a and 5b.

On the first clamping leg 5a of the rail slider 5, on the side of the leg facing away from the receiving gap 11, a rail wrap 13 with an approximately L-shaped cross-section is formed. With the rail wrap 13 on the first clamping leg 5a, the rail slider 5 sits on a correspondingly shaped rail section of, for example, the roughly hat-shaped guide rail 7 in the assembled state of the window regulator assembly 1 and is guided and held on it. The first clamping leg 5a is therefore also referred to in the following as the fixed clamping leg of the rail slider 5. On the first clamping leg 5a of the rail slider 5, on the side of the leg facing away from the receiving gap 11, a joining chamber 14 is molded as a so-called nipple chamber for cable nipples at the end of the respective traction cable 6 of the cable pull of the window regulator assembly 1, which is preferably designed as a Bowden cable.

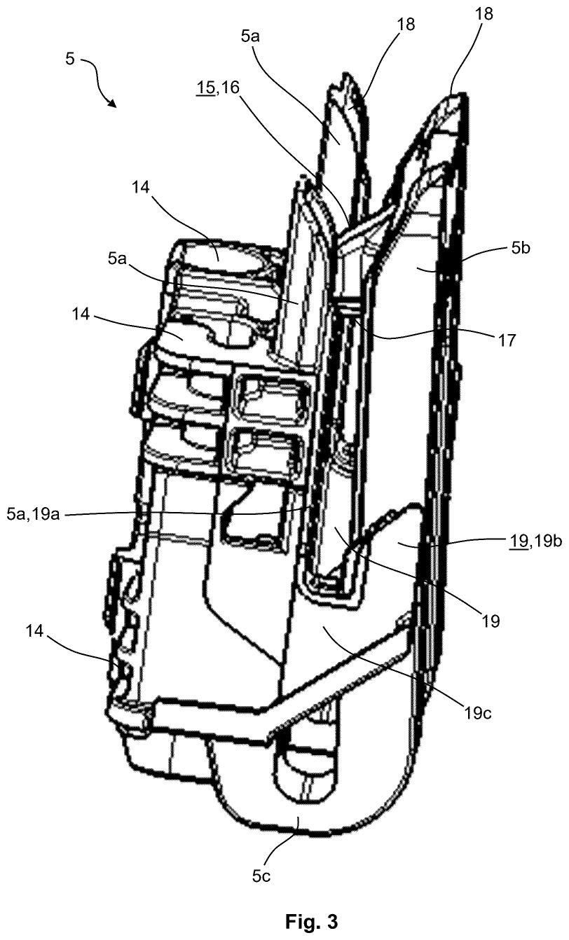

Compared to the first, fixed clamping leg 5a, the second clamping leg 5b of the rail slider 5a can be elastically relocated or flexurally deformed and is therefore movable, especially in the Y-direction. A locking element 15 is molded to the second clamping leg 5b, which is also referred to as movable in the following, which protrudes into the receiving gap 11 (in the Y-direction). The locking element 15 is designed as a locking hook, in particular triangular, and has an inlet slope 16 inclined to the connecting leg 5c and a locking edge 17 (FIG. 3) which is without slope to the gap opening 12 of the receiving gap 11 and normal (vertical) to the XZ-plane of the second (movable) clamping leg 5b.

The clamping legs 5a and 5b each have an inlet slope 18 in the area of the gap opening 12 of the receiving gap 11 (FIG. 3). The window pane 2 can be inserted easily and fail-safely via the inlet slopes 18 on the leg side in the area of the gap opening 12 of the rail slider 5 in its receiving gap 11. The window pane 2 is inserted with its lower edge, marked 20 in FIG. 1, first over the gap opening 12 into the receiving gap 11 and between the two clamping legs 5a and 5b of the rail slider 5 and locked in the receiving gap 11. In this case, the window pane 2 slides with its lower edge along the inclined inlet slope 16 of the locking element 15. In this process, the second, movable clamping leg 5b of the rail slider 5 is bent open elastically in the Y-direction, and the locking element 15 engages, in particular in a form-fitting manner, in a corresponding locking opening of the window pane 2 in an unspecified manner.

On the first clamping leg 5a of the rail slider 5, U-shaped support contours 19 are formed on both sides of the receiving gap 11 to form a flat two-point support for the window pane 2. The distance between the outer edges or outer surfaces of the support contours 19 spaced from each other in the gap transverse direction Q (X direction) to the gap longitudinal direction L outside the receiving gap 11, hereinafter referred to as the outer distance a, is preferably less than the (slider) length b of the rail slider 5 in the gap longitudinal direction L. In the example, the outer distance a of the support contours 19 is about 70% of the (slider) length b of the rail slider 5 in the gap longitudinal direction L. The ratio of the outer distance a of the support contours 19 to the (slider) length b of the rail slider 5 is in particular between a/b=0.5 and a/b=1.

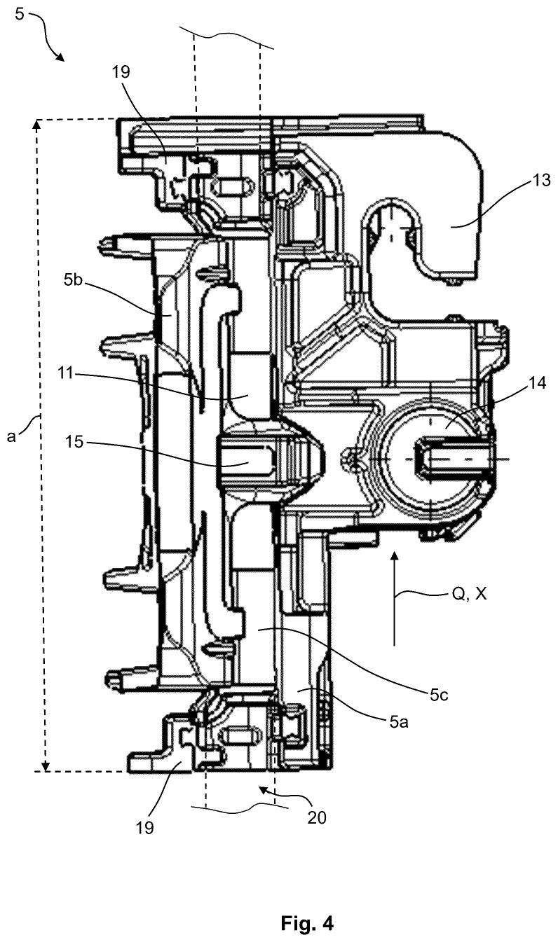

As can be seen comparatively clearly in FIG. 4, one of the two support contours 19 is molded directly opposite the rail wrap 13 on the first clamping leg 5a of the rail slider 5. The support contours 19 are directly or immediately adjacent to the side of the receiving gap 11.

The respective support contour 19 has a first U-leg 19a and a second U-leg 19b. The first U-leg 19a is formed by the first clamping leg 5a or by a corresponding leg section of the first clamping leg 5 in the gap longitudinal direction L of the rail slider 5. The second U-leg 19b, hereinafter also referred to as the free leg, is molded to the first clamping leg 5a of the rail slider 5 via a connecting leg 19c. The connecting leg 19c is molded to the first clamping leg 5a, perpendicular to the clamping leg 5a or to the first U-leg 19a or runs in the Y-direction. The connecting leg 19c of the respective U-shaped support contour 19 forms the groove bottom 19d of the respective support contour 19.

The second (free) U-leg 19b of the respective support contour 19 protrudes beyond the receiving gap 11 in the X-direction or laterally in the direction of the other clamping leg 5b of the rail slider 5 with only slight, preferably the smallest possible or minimal, gap formation to the movable second clamping leg 5b.

The support contour 19 as a U-shaped support groove aligns with the receiving gap 11, wherein the groove bottom 19d practically forms a flat support of the support contour 19 for the lower edge 20 of the window pane 2, which is indicated in FIG. 4 as a pair of dotted lines. The contour sides of the support contours 19 and the U-legs or groove legs of the support contours 19 facing away from the receiving gap 11 align with the lateral outer edge or outer surface of the first clamping leg 5a of the rail slider 5. In this case, the support contours 19 provided outside the receiving gap 11 overlap the second clamping leg 5b at least partially or with the free U-leg.

The leg edges or leg surfaces of the two clamping legs 5a and 5b of the rail slider 5, which are oriented in the gap longitudinal direction L, run parallel to each other and/or to the respective other clamping leg 5b or 5a. An elastic component (soft-component) 21 of the rail slider 5, which is preferably manufactured as a two-component plastic injection part (2K injection molded part), is provided in the support contours 19. Such a soft component 21 is also provided in the area of the receiving or pane gap 11 on the clamping legs 5a, 5b of the rail slider 5 (FIG. 2).

In summary, the invention relates to a window regulator assembly 1 for an adjustable window pane 2 of a motor vehicle, comprising a rail slider 5 with two clamping legs 5a, 5b, between which a receiving gap 11 for the window pane 2 is formed, wherein mutually spaced support contours 19 are molded to one of the clamping legs 5a on both sides of the receiving gap 11, preferably to form a two-point support, for window pane 2.

The invention is not limited to the examples described above. Rather, other variants of the invention can also be derived by the skilled person from this without departing from the subject-matter of the invention. In particular, all the individual features described in connection with the example can also be combined with each other in other ways without departing from the subject-matter of the invention.

What is claimed is:

1. A window regulator assembly for an adjustable window pane of a motor vehicle, the window regulator assembly comprising:
a rail slider adapted to be moved on a guide rail with first and second clamping legs connected via at least one connecting leg; and
a receiving gap formed between the first and second clamping legs for the window pane with a gap longitudinal direction oriented between a gap opening and the or each connecting leg,
wherein the first clamping leg is designed to hold and guide the rail slider on the guide rail,
wherein the second clamping leg is elastically relocated in relation to the first clamping leg and has a locking element protruding into the receiving gap for a locking connection with the window pane, and
wherein, on the first clamping leg, on both sides of the receiving gap, mutually spaced support contours for the window pane are molded to each other.

2. The window regulator assembly according to claim 1, wherein the support contours are molded to the first clamping leg to form a two-point support for the window pane, and/or wherein an outer distance of the support contours is less than or equal to a length of the rail slider in the gap longitudinal direction, and/or wherein a ratio of the outer distance (a) of the support contours to the slider length (b) of the rail slider is between a/b=0.5 and a/b=1, and/or wherein the leg edges or leg surfaces of the two clamping legs of the rail slider oriented in the gap longitudinal direction run parallel to each other or to the respective other clamping leg.

3. The window regulator assembly according to claim 1, wherein the respective support contour is hook-shaped or U-shaped and/or designed as a U-shaped support groove, and/or wherein the respective support contour is U-shaped with a first U-leg and with a second U-leg, wherein the first U-leg is formed by the first clamping leg of the rail slider, and wherein the second U-leg is molded to the first clamping leg of the rail slider via a connecting leg, and/or wherein the respective support contour supports the window pane inwards in the Y-direction and outwards in the Y-direction, and/or wherein the respective support contour supports the window pane downwards in the Z-direction.

4. The window regulator assembly according to claim 1, wherein the contour sides of the respective support contour or the U-leg facing away from the receiving gap align with the first clamping leg or with its outer edge or outer leg surface.

5. The window regulator assembly according to claim 1, wherein the first clamping leg of the rail slider has a rail wrap for the guide rail, wherein one of the support contours is molded directly opposite the rail wrap to the first clamping leg of the rail slider.

6. The window regulator assembly according to claim 1, wherein the support contours are provided outside the receiving gap and/or overlap the second clamping leg at least partially.

7. The window regulator assembly according to claim 1, wherein the rail slider is a two-component plastic component with a soft component provided in the support contours.

8. The window regulator assembly according to claim 1, wherein the clamping legs of the rail slider are connected by mutually spaced connecting legs or U-or V-shaped, or flared or protruding in the gap longitudinal direction.

9. The window regulator assembly according to claim 1, wherein the locking element has an inlet slope inclined to the or to each connecting leg, and/or wherein the locking element has a locking edge without a slope to the gap opening of the receiving gap.

10. A rail slider for a window regulator or a window regulator assembly according to claim 1, comprising:
a first clamping leg; and
a second clamping leg,
wherein the clamping legs are connected by at least one connecting leg and the second clamping leg is adapted to be elastically relocated in relation to the first clamping leg,
wherein, between the clamping legs, a receiving or clamping gap is formed with a gap longitudinal direction oriented between a gap opening and the connecting leg, and
wherein mutually spaced support contours are molded to one of the clamping legs on both sides of the receiving gap, an outer distance of which is less than a slider length in a gap longitudinal direction.
